(19) United States
(12) Patent Application Publication
(10) Pub. No.: US 2022/0136834 A1
(43) Pub. Date: May 5, 2022

(54) Determination of Relative Pose Using Artificial Magnetic Fields

(71) Applicants: Jeff Wesley Fisher, VOLCANO, CA (US); Mark Brian Spence, Tucson, AZ (US)

(72) Inventors: Jeff Wesley Fisher, VOLCANO, CA (US); Mark Brian Spence, Tucson, AZ (US)

(73) Assignee: Deerwood Medical Devices, VOLCANO, CA (US)

(21) Appl. No.: 17/519,309

(22) Filed: Nov. 4, 2021

Related U.S. Application Data
(60) Provisional application No. 63/109,856, filed on Nov. 4, 2020.

(51) Int. Cl. G01C 21/16; G01S 5/00

(52) U.S. Cl. CPC G01C 21/165; G01P 15/18; G01S 5/00

(57) ABSTRACT

The pose or position and orientation of a wearable sensor assembly in a reference coordinate system are to be determined in real-time. One or more artificial magnetic field sources are located with known positions and orientations in the reference coordinates. Each source generates a magnetic field which varies in time according to a predetermined AC pulse code, so that each source is uniquely identifiable and distinguishable from ambient DC fields. The magnitude and direction in wearable coordinates of the AC magnetic field due to each source varies in a modelable way with position and orientation of the wearable, which comprises a nine-channel Inertial Measurement Unit (IMU) and a processor. The IMU senses the inertial motion of the wearable and the time-varying magnetic field to which it's exposed. These data are processed to estimate the position and orientation of the wearable in reference coordinates, along with various constant parameters.

### CROSS-REFERENCE TO RELATED APPLICATIONS

This application benefits from provisional patent application Ser. No. 63/109,856, filed 2020 Nov. 4 by the present inventors.

### STATEMENT REGARDING FEDERALLY SPONSORED RESEARCH OR DEVELOPMENT

Not applicable

### PRIOR ART

### U.S. Patents

| Pat. No. | Issue Date | Patentee |
|---|---|---|
| 6,381,485 | 2002 Apr. 30 | Hunter |
| 5,357,437 | 1994 Oct. 18 | Polvani |
| 3,868,565 | 1975 Feb. 25 | Kuipers |

### Nonpatent Literature

[Bar] Billur Barshan and Hugh F. Durrant-Whyle, “Inertial Navigation Systems for Mobile Robots,” IEEE Transactions on Robotics and Automation, Vol. 11, No. 3, June 1995, pp. 328-342
[Deu] Julie K. Deutschmann and Itzhack Y. Bar-Itzhack, “Evaluation of Attitude and Orbit Estimation Using Actual Earth Magnetic Field Data,” Journal of Guidance, Control, and Dynamics, Vol. 24, No. 3, May-June 2001, pp. 616-623
[Fan] Bingfei Fan, Qingguo Li, and Tao Liu, “How Magnetic Disturbance Influences the Attitude and Heading in Magnetic and Inertial Sensor-Based Orientation Estimation,” Sensors, Vol. 18, 2018
[Fis1] Jeff W. Fisher and Mark B. Spence, “Pose Determination Using Artificial Magnetic Fields,” in preparation for submittal to IEEE Transactions on Control Systems Technology
[Fis2] Jeff W. Fisher and Mark B. Spence, “Relative Navigation Using Artificial Magnetic Fields,” accepted for publication, 44th Annual AAS Guidance & Control Conference, Breckenridge, Colo., 8 Feb. 2022
[Fis3] Jeff Wesley Fisher, “Low Cost Spacecraft Attitude Determination By Magnetic Orbital Gyrocompassing,” AAS 99-436, AAS/AIAA Astrodynamics Specialist Conference, Girdwood, Ak., 16-19 Aug. 1999
[Fis4] Jeff Wesley Fisher, A Magnetic Orbital Gyrocompass, PhD dissertation, Stanford University Department of Aeronautics and Astronautics, 1995
[Fox] S. M. Fox, P. K. Pal, and M. Psiaki, “Magnetometer-Based Autonomous Satellite Navigation (MAGNAV),” AAS 90-051, 13th Annual AAS Guidance and Control Conference, Keystone, Colo., 3-7 Feb. 1990
[Mad] Sebastian O. H. Madgwick, Andrew J. L. Harrison, and Ravi Vaidyanathan, “Estimation of IMU and MARG orientation using a gradient descent algorithm,” 2011 IEEE International Conference on Rehabilitation Robotics, Zurich, Switzerland, Jun. 29-Jul. 1, 2011
[Psi1] Mark L. Psiaki, “Global Magnetometer-Based Spacecraft Attitude and Rate Estimation,” AIAA 2003-5561, AIAA Guidance, Navigation, and Control Conference and Exhibit, Austin, Tex., 11-14 Aug. 2003
[Psi2] M. L. Psiaki, F. Martel, and P. K. Pal, “Three-Axis Attitude Determination via Kalman Filtering of Magnetometer Data,” Journal of Guidance, Control, and Dynamics, Vol. 13, No. 3, May-June 1990, pp. 506-514
[Sab1] Angelo M. Sabatini, “Estimating Three-Dimensional Orientation of Human Body Parts by Inertial/Magnetic Sensing,” Sensors, Vol. 11, 2011, pp. 1489-1525
[Sab2] Angelo Maria Sabatini, “Quaternion-Based Extended Kalman Filter for Determining Orientation by Inertial and Magnetic Sensing,” IEEE Transactions on Biomedical Engineering, Vol. 53, No. 7, July 2006, pp. 1346-1356
[Sil] Felipe O. Silva, Rogerio P. Menezes Filho, Leonardo A. Vieira, Helio K. Kuga, and Ettore A. de Berros, “Three-Axis Attitude Determination with Pseudo-Bias Estimation from Gravity/Magnetic Vector Observations,” Journal of Guidance, Control, and Dynamics, Vol. 43, No. 12, December 2020, pp. 2237-2257
[Sti] Ross Stirling, Ken Fyfe, and Gerard Lachapelle, “Evaluation of a New Method of Heading Estimation for Pedestrian Dead Reckoning Using Shoe Mounted Sensors,” The Journal of Navigation, Vol. 58, 2005, pp. 31-45
[Sto] William Storms, Jeremiah Shockley, and John Raquet, “Magnetic Field Navigation in an Indoor Environment,” Proceedings of 2010 IEEE Ubiquitous Positioning Indoor Navigation and Location Based Service, 14-15 Oct. 2010

### BACKGROUND OF THE INVENTION

The pose of an object is the six-dimensional (6D) quantity comprising its position and orientation in some reference coordinate system. The capability to determine an object's pose in real-time is a key requirement for applications as diverse as
(a) guiding mobile robots,
(b) rendering scenes for VR/AR headsets,
(c) tracking personnel or equipment inside a building,
(d) precision unmanned aircraft landings,
(e) aerial refueling,
(f) navigation of submersibles for inspecting deepsea platforms, and
(g) docking spacecraft.

Individual sensors generally provide only partial information on the state of pose. Determination of 6D pose over time requires a system containing multiple sensors and sensor types and a specialized data processing algorithm. Analysts evaluate the information content provided by a given sensor suite in terms of the state observability, a mathematical quantity which can be rigorously defined.

Numerous solutions for estimating 6D pose are known, each with its own strengths and weaknesses. GPS and other Global Navigation Satellite Systems are excellent choices for outdoor operation, but are not available indoors. RFID and other RF sources can be installed inside a building, but are degraded by walls and other metal objects. Optical sensors impose heavy computation loads and are strictly limited to clear lines of sight from sensor to source.

Inertial sensors also give partial information on pose, providing high bandwidth, low noise, and state memory. Data from inertial and non-inertial sensors are often fused, leveraging their complementary features and deemphasizing their individual weaknesses. Standalone inertial navigation can also be effective, but only over a finite duration. Inertial sensor errors result in drift of the state estimate, requiring correction by other sensors for long term operation (Bar).

Many authors (Sil, Fan, Mad, Sab1, Sto, Sab2, Sti) have studied pose estimators incorporating measurements of the Earth's magnetic field by a three-axis Magnetometer. Magnetic fields are well suited for indoor applications; but for terrestrial use, accuracy of these estimators is poor, because
(a) the Earth's field shows insufficient variation with position and
(b) spurious local magnetic field sources distort the field (Fan).

Other authors (Psi1, Deu, Fis3, Psi2, Fox) have shown that Earth's magnetic field is well suited to pose estimation for orbiting spacecraft. The orbital application is different because
(a) the magnetic field at orbital distances approximates that of a dipole, varying strongly with position, and
(b) the spacecraft's position changes quickly enough to make all six components of pose observable (Fis4, Fox).

Polvani (U.S. Pat. No. 5,357,437) placed permanent magnets in selected locations, intentionally creating field distortions which could be modeled and which varied over distance scales useful for underwater navigation. Hunter (U.S. Pat. No. 6,381,485) applied a similar concept to surgical procedures. We show in (Fis2) that this scheme is effective for position determination, but only if orientation is independently measured. Kuipers (U.S. Pat. No. 3,868,565) used air core electric coils rather than permanent magnets. He was able to make 6D pose observable by
(a) using multiple emitting and receiving coils and
(b) mounting the emitting coils on rotating platforms.

Our invention uses electromagnets as artificial field emitters. Our key innovation is that our Emitter excitations, and hence the magnetic fields they produce, are modulated, each with a unique code. When the sensed magnetic field is demodulated, separate signals are produced for each Emitter. Moreover, the DC fields due to the Earth and any local sources are strongly rejected, and Magnetometer bias errors are canceled out. Our analysis and testing (Fis1, Fis2) show that Emitter fields 50X smaller than the Earth's field are cleanly extracted.

### BRIEF SUMMARY OF THE INVENTION

One or more electromagnets or Emitters are energized with prescribed time-varying sequences of magnetization. Each sequence is a unique AC code, so the signal from each Emitter may be distinguished from its peers and from spurious DC fields. The components in a reference coordinate system of the resulting net magnetic field vary with time and position according to a defined model.

In one embodiment, a Magnetometer senses the time-varying components in the Magnetometer coordinate system of the magnetic field value at the time-varying Magnetometer location. A data processing algorithm estimates the time-varying values of Magnetometer pose by reconciling the measured field components with position- and orientation-dependent model predictions.

In another embodiment, components of angular velocity and acceleration measured by an IMU are fused with the magnetometer measurements. This improves the response time and the accuracy of the pose estimate.

Our invention works indoors and is not sensitive to ambient magnetic field sources. Our invention is also low cost, as electromagnets are very simple devices and mass-produced iPhone-class IMUs yield adequate performance.

### BRIEF DESCRIPTION OF THE DRAWINGS

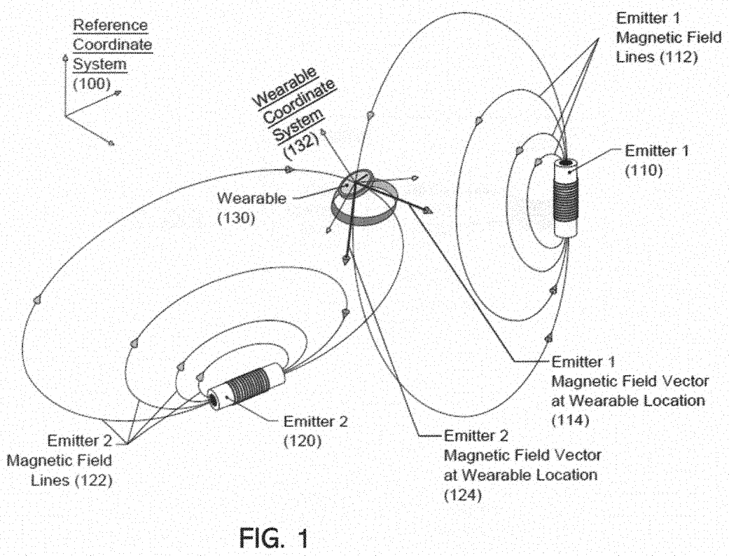

FIG. 1 An embodiment with two Emitters in a fixed Reference Coordinate System and a Wearable
100 Reference Coordinate System
110 Emitter 1
112 Emitter 1 magnetic field lines
114 Emitter 1 magnetic field vector at Wearable location
120 Emitter 2
122 Emitter 2 magnetic field lines
124 Emitter 2 magnetic field vector at Wearable location
130 Wearable
132 Wearable Coordinate System

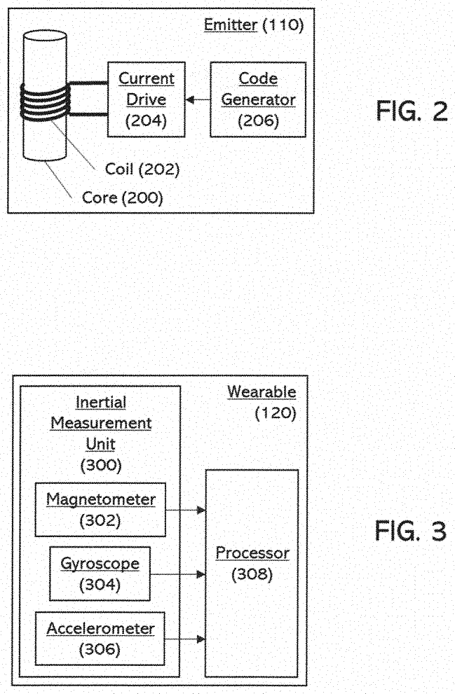

FIG. 2 Emitter
200 Permeable core
202 Copper coil
204 Current drive
206 Code Generator

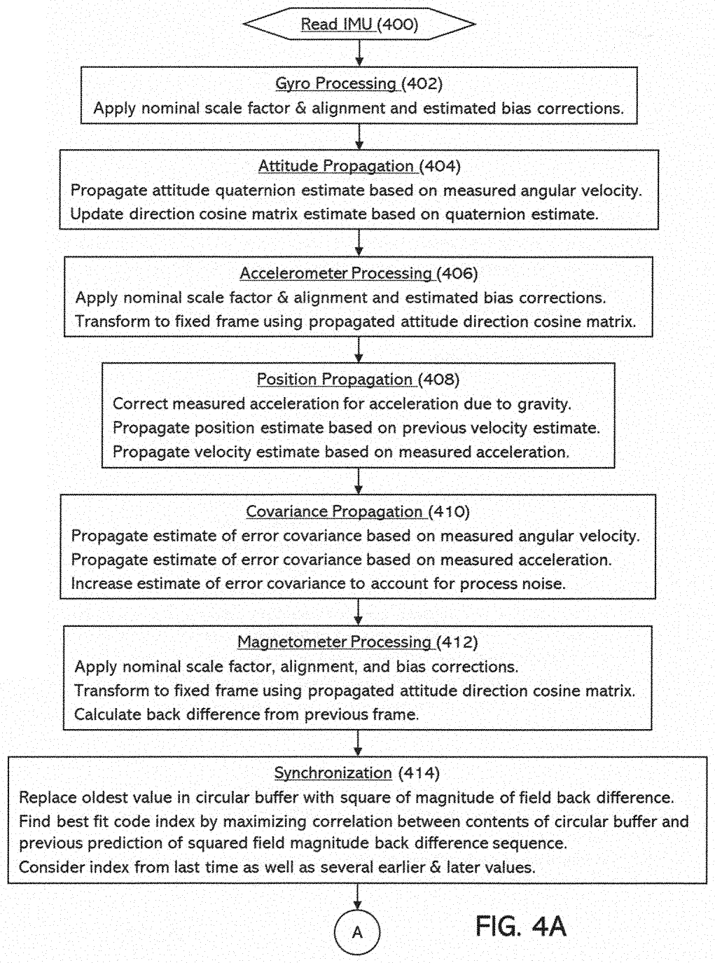

FIG. 3 Wearable Sensor Assembly
300 9-Channel Inertial Measurement Unit (IMU)
302 3-Axis Magnetometer
304 3-Axis Gyroscope
306 3-Axis Accelerometer
308 Processor

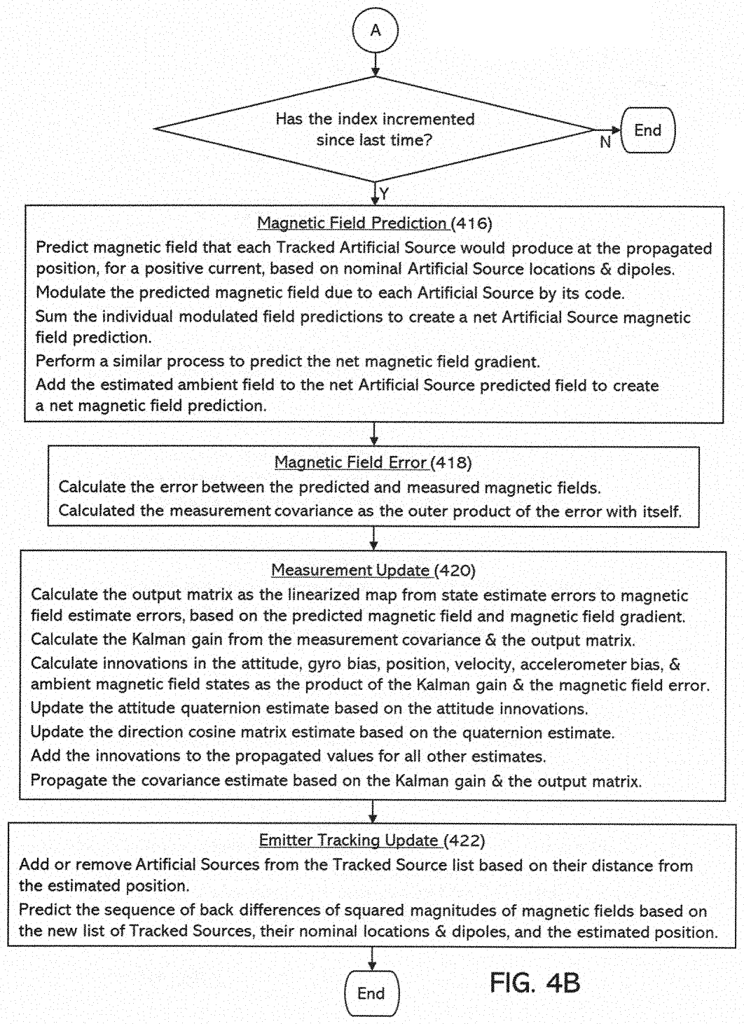

FIGS. 4A & 4B An embodiment of the Pose Estimation Algorithm using a 9-Channel IMU
400 Algorithm Step 1, Read IMU
402 Algorithm Step 2, Gyro Processing
404 Algorithm Step 3, Attitude Propagation
406 Algorithm Step 4, Accelerometer Processing
408 Algorithm Step 5, Position Propagation
410 Algorithm Step 6, Covariance Propagation
412 Algorithm Step 7, Magnetometer Processing
414 Algorithm Step 8, Synchronization
416 Algorithm Step 9, Magnetic Field Prediction
418 Algorithm Step 10, Magnetic Field Error
420 Algorithm Step 11, Measurement Update
422 Algorithm Step 12, Emitter Tracking Update

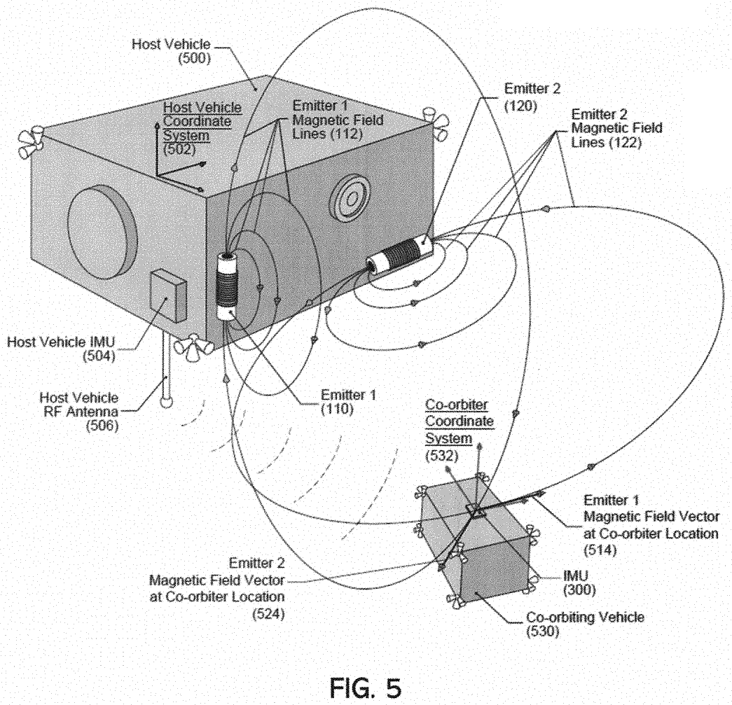

FIG. 5 An embodiment with two Emitters for co-orbiting spacecraft relative motion
500 Host Vehicle
502 Host Vehicle Coordinate System
504 Host Vehicle IMU
506 Host Vehicle RF antenna
514 Emitter 1 magnetic field vector at Co-orbiting Vehicle location
524 Emitter 2 magnetic field vector at Co-orbiting Vehicle location
530 Co-orbiting Vehicle
532 Co-orbiting Vehicle Coordinate System

### DETAILED DESCRIPTION OF THE INVENTION

### First Embodiment (FIGS. 1 Through 4)

One embodiment of the invention is shown in FIG. 1. A Reference Coordinate System (100) is defined. It may be inertially fixed or approximated as inertially fixed; for instance, it may be fixed in a room which rotates with the Earth. One or more Artificial Magnetic Field Sources or Emitters (110, 120) are placed in the Reference Coordinate System such that the locations and orientations of the Emitters in Reference coordinates are known. Each Emitter creates a magnetic field (112, 122) whose magnitude and direction vary in a modelable way with position. Each Emitter modulates its output with a predetermined pulse code that makes each Emitter's magnetic field uniquely identifiable and distinguishable from other field sources.

A Wearable device (130) is free to translate and rotate with respect to the Reference Coordinate System. Attached to the Wearable is its own Wearable Coordinate System (132). The Wearable senses the time-varying values of 1) its inertial angular velocity, 2) its nongravimetric inertial acceleration, and 3) the magnetic field to which the Wearable is exposed. The Wearable uses its sensed data to estimate in real-time the time-varying values of the position and orientation of the Wearable Coordinate System with respect to the Reference Coordinate System.

FIG. 2 shows the construction of each Emitter. A conducting Coil (202) is wrapped around a solid Core (200) made of any material with high magnetic permeability. A Current Drive electronic circuit (204) pushes current around the Coil, inducing a magnetic field. The Current Drive modulates the current according to a pulse code output by a Code Generator (206).

FIG. 3 shows the hardware components of the Wearable. An Inertial Measurement Unit or IMU (300) comprises three types of sensor: a three-axis Magnetometer (302), a three-axis Gyroscope or Gyro (304), and a three-axis Accelerometer (306). The IMU is typically a monolithic integrated circuit using solid state devices based on Hall Effect and MEMS technology. But it could also be a set of individual components, and the components could use alternate sensing technologies to achieve higher performance. Alternate sensing technologies include fluxgates or other types of magnetometers; vibrating mass gyros, fiber optic gyros, ring laser gyros, spinning rotor gyros, or other types of gyroscopes; and seismic mass, vibrating mass, or other types of accelerometers. Sensor data from the IMU are read at a uniform sample rate by a Processor (308).

The Processor processes the sensor data with a strapdown navigation or Pose Estimation Algorithm as shown in FIGS. 4A and 4B. The Algorithm estimates some eighteen quantities or states: three attitude or orientation angles, three components of Gyro bias, three components of position, three components of velocity, three components of Accelerometer bias, and three components of non-Emitter magnetic field. The Algorithm also calculates the estimate covariance or uncertainty. There are twelve major steps executed once per sample frame, as follows.

First, the current IMU outputs are read (400). Then the Gyro outputs are preprocessed (402) and used to propagate (404) the orientation or attitude estimate from its value at the previous sample time to its predicted value at the present sample time. Then the Accelerometer outputs are preprocessed (406) and used to propagate (408) the velocity and position estimates. Then the Gyro and Accelerometer data are used to propagate (410) the estimate covariance or uncertainty estimate.

Next, the Magnetometer outputs are preprocessed (412). Then, the recent history of the Magnetometer data is used to synchronize (414) the Wearable clock with the time base used by the Emitters.

After synchronization, if the pulse code has not incremented since the last sample, the algorithm terminates and the predicted position, velocity, and attitude are taken as the estimated position, velocity, and attitude. Otherwise, the algorithm continues as follows.

The propagated position and attitude are used to predict (416) the Magnetometer measurements. The predictions are differenced with those measurements to create error signals (418). Then a measurement update (420) is used to improve the estimates of all eighteen states, along with the covariance. The estimation algorithm is typically an Extended Kalman Filter, but it could also be an alternate estimation algorithm such as the Square Root Covariance Filter, Information or Square Root Information Filter, Particle Filter, Unscented Kalman Filter, Quadrature Kalman Filter, Cubature Kalman Filter, or other Bayesian or Least Squares estimation algorithm. It could also be an AI algorithm such as a convolutional neural network or any other data fusion algorithm.

Finally, a dynamic list of Emitters in range is updated (422). This list is used to improve the computational efficiency of the Synchronization step (414).

### Advantages

The choice of states to estimate is based on our analysis of state observability, coupled with our experiments on performance of low cost IMUs and interfering DC magnetic fields (Fis1). This research provides guidelines for sizing and locating Emitters. It shows that two properly located Emitters are sufficient to produce pose estimates which are long term stable and accurate to centimeters; that Emitters placed periodically around a space of interest can provide unlimited coverage range; and that performance is rather insensitive to Emitter placement.

Our invention is ideal for use indoors, where GPS signals typically are not available. Because the Emitter fields are encoded AC, it is not sensitive to the Earth's magnetic field or spurious magnetic field sources. Unlike systems based on optical or RF signals, it does not require clear lines of sight from signal source to Wearable. It's also very low cost, as the Wearable can use IMU hardware found in existing mobile devices.

### Second Embodiment

In another embodiment, the Wearable does not incorporate the Gyroscope and Accelerometer. While the system's time response may be slower, our research (Fis2) shows that two or more properly placed Emitters are sufficient to make the 6D pose observable from the Emitter magnetic fields alone. Alternately, data from any other type of pose sensor may be fused with the Magnetometer data to improve accuracy or response time.

### Third Embodiment

In another embodiment, the Reference Coordinate System is not inertially fixed. For example, the Reference Coordinate System could be attached to a spacecraft in orbit, the Emitters could be mounted in that spacecraft, and the objective could be determination of the relative pose of a co-orbiting spacecraft (FIG. 5). An additional set of inertial sensors is attached to the Reference Coordinate System, and the data from those sensors is transmitted to the Processor. The Gyro and Accelerometer outputs from the IMU are differenced with the corresponding outputs from the Reference to produce relative angular velocity and acceleration components. The relative angular velocity and acceleration are used in the Pose Estimation Algorithm, which otherwise is unchanged.

### Fourth Embodiment

In another embodiment, the Wearable is mechanically constrained to have fewer than six degrees of freedom. The Pose Estimation Algorithm is modified to take the constrained coordinates as given and estimate only the unconstrained coordinates. Sensors or individual sensor channels which become redundant may be eliminated.

1. A method for determining relative pose, comprising one or more magnetic field Emitters, a Wearable sensor assembly whose pose is to be determined, and a Pose Estimation Algorithm.

2. The Emitters of claim 1, each said Emitter further having known location and orientation in an inertially fixed or nearly inertially fixed Reference Coordinate System.

3. The Emitters of claim 2, each said Emitter further modulating its output magnetic field with a predetermined AC pulse code.

4. The Wearable of claim 1, further comprising an Inertial Measurement Unit (IMU) and a Processor.

5. The IMU of claim 4, further comprising a three-axis Gyroscope, a three-axis Accelerometer, and a three-axis Magnetometer.

6. The Processor of claim 4, further reading data periodically from said IMU and processing said data in said Pose Estimation Algorithm.

7. The Pose Estimation Algorithm of claim 1, further comprising the twelve major steps Read IMU, Gyro Processing, Attitude Propagation, Accelerometer Processing, Position Propagation, Covariance Propagation or any method of uncertainty propagation, Magnetometer Processing, Synchronization, Magnetic Field Prediction, Magnetic Field Error, Measurement Update by Kalman Filter innovations or any state estimation method or any means of calculating parameter values from measured data, and Emitter Tracking Update.

8. An alternate method for determining relative pose, comprising one or more magnetic field Emitters, a Wearable sensor assembly without inertial instruments, and an appropriately modified Pose Estimation Algorithm.

9. A method for determining pose of one moving body relative to another, comprising one or more magnetic field Emitters mounted on a Reference Body, inertial instruments mounted on said Reference Body, a Wearable sensor assembly whose pose relative to the Reference Body is to be determined, and an appropriately modified Pose Estimation Algorithm.

10. A method for determining unknown components of relative pose, given that one or more components are already known, comprising one or more magnetic field Emitters, a Wearable sensor assembly with fewer than six channels of inertial instruments, and an appropriately modified Pose Estimation Algorithm.
